(19) United States
(12) Patent Application Publication
(10) Pub. No.: US 2024/0220866 A1
(43) Pub. Date: Jul. 4, 2024

(54) MULTIMODAL MACHINE LEARNING FOR GENERATING THREE-DIMENSIONAL AUDIO

(71) Applicant: International Business Machines Corporation, Armonk, NY (US)

(72) Inventors: Ismael Faro Sertage, Chappaqua, NY (US); Juan Cruz Benito, Salamanca (ES); Francisco Jose Martin Fernandez, Ridgefield, CT (US)

(21) Appl. No.: 18/090,418

(22) Filed: Dec. 28, 2022

(30) Foreign Application Priority Data
Oct. 28, 2022 (EP) 22383044.9

(51) Int. Cl. G06N 20/20; G06N 3/045

(52) U.S. Cl. CPC G06N 20/20; G06N 3/045

(57) ABSTRACT

Methods and systems use one or more machine learning models to automatically generate three-dimensional sound. A multimodal content item is accessed by a computing device. Three-dimensional sound is automatically generated by the computing device using the one or more machine learning models based on the multimodal content item.

### CROSS-REFERENCE TO RELATED APPLICATIONS

This application claims foreign priority to European Patent Application EP 22383044 filed 28 Oct. 2022, the complete disclosure of which is expressly incorporated herein, in its entirety, for all purposes.

### BACKGROUND

The present invention relates generally to the electrical, electronic and computer arts and, more particularly, to multimodal machine learning.

Machine learning (ML) and deep learning (DL) methods and models have recently been applied to multimodal applications. Conventional algorithms and procedures mix various data sources, such as images, text, audio, and the like (thus, “multimodal”). Conventional techniques combine pictures and text, audio and text, audio and video, and the like, to generate new content. For example, conventional methods are capable of describing textually what is happening in an image or video, generating images from a text description, performing speech-to-text tasks in more efficient ways, and generating three-dimensional virtual reality experiences based, for example, on the audio of a concert. The use of ML and DL techniques and algorithms to manage audio is also a recent trend, and includes the generation of audio and audio dissection.

### BRIEF SUMMARY

Principles of the invention provide multimodal machine learning for generating three-dimensional audio. In one aspect, an exemplary method includes the operations of accessing, by a computing device, a multimodal content item and automatically generating, by the computing device, new three-dimensional sound using the one or more machine learning models based on the multimodal content item.

In one aspect, an apparatus comprises a memory and at least one processor, coupled to the memory, and operative to perform operations including accessing a multimodal content item; and automatically generating new three-dimensional sound using one or more machine learning models based on the multimodal content item.

In one aspect, a non-transitory computer readable storage medium comprising computer executable instructions which when executed by a computer cause the computer to perform the method of: accessing a multimodal content item; and automatically generating new three-dimensional sound using one or more machine learning models based on the multimodal content item.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
audio augmentation for multimodal content on a software as a service (SaaS) or other platform;
improved audio experience quality for multimodal content, such as movies, gaming, and the like;
an embeddable audio augmentation architecture for hardware devices;
generation of complementary audio tracks for multimodal content; and
improve the technological process of computerized generation of three-dimensional audio by using machine learning to augment source audio and images that do not include three-dimensional audio.

Some embodiments may not have these potential advantages and these potential advantages are not necessarily required of all embodiments. These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a high-level block diagram of an example system for generating three-dimensional audio, in accordance with an example embodiment; and

FIG. 2 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

As will be appreciated by the skilled artisan, the real world provides an individual with digital entertainment, including visualizing videos, listening to music, podcasts, playing video games, and the like. A major part of digital media uses stereo sound settings, in which the user can differentiate the audio as provided by two channels (left and right). Although stereo sound is a conventional standard, better audio solutions exist, such as three-dimensional (3D) audio. Three-dimensional (3D) audio (also known as audio 360 and holophonic audio) refers, for example, to audio techniques that generate audio that mimics realistic environments in which the sound sources are located in three-dimensional space in relation to the listener, including, for example, above, below, behind, in front of, and to the side of the listener. Most audio experiences, however, are not designed to use 3D audio, even when many users are able to experience it using standard headphones.

Generally, methods and systems are disclosed that use multimodal machine learning (ML) methods and procedures to automatically produce 3D audio using input images and/or audio from videos, films, video games, and the like. It is noted that most audio in modern media, films, and video games is stereo. Common devices, such as headphones, theatre systems, and the like, can reproduce better audio environments than stereo sound. Most media creators, however, do not have access to the tools and knowledge to create 3D audio experiences. One or more embodiments enable the automatic creation of richer audio experiences that can more effectively engage users of the media and improve their experience while consuming digital media.

In one example embodiment, algorithms are applied to a sequence of images (from a movie, a videogame, and the like) and their associated audio tracks to segment the image streams and the audio tracks according to a corresponding element (such as an image object, an audio object (also referred to as a sound object herein), and the like), and to relate the image elements to the audio effects that they produce. The algorithms are also applied on the source image to label the position and trajectory of each image and audio object. The processing also tracks the evolution of each image object and audio object during a given time period.

Based on the outputs of the segmentation and identification operations, an association algorithm connects the elements of the audio channels with the source image elements in the scene (image) such that the evolution of each portion of the image can be tracked with the evolution of the corresponding sound(s). Using that knowledge, and the richer spatial information available from the input image, an audio generation algorithm modifies and augments the soundtracks of the multimodal content to generate complementary audio tracks/channels that, for example, more accurately capture the spatial information provided by the image. For example, if an image of a dog is identified in a background of a video frame, a dog bark from a right channel may be echoed in a left channel. If the sound of the wind is detected behind a viewer, a sound of the wind may be generated in front of the viewer. If image object labels identifying a train station and people, respectively, are encountered, an “all aboard” call is generated. Thus, an evolved cohort of new audio tracks/channels are developed that are more realistic for the observed scene and that behave like three-dimensional audio for the systems, environments, and devices that support 3D audio.

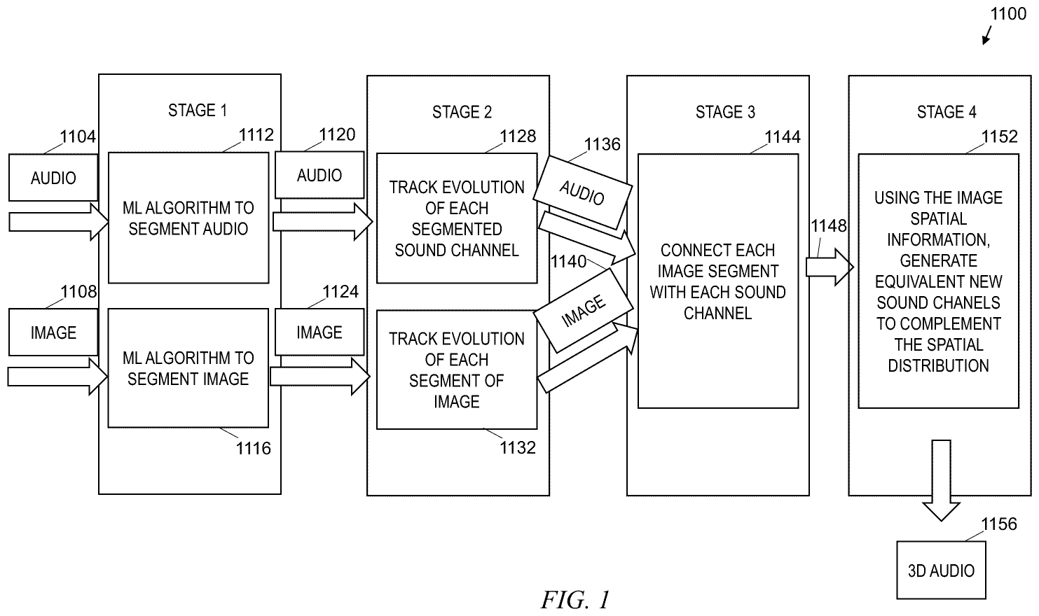

FIG. 1 is a high-level block diagram of an example system 1100 for generating three-dimensional audio, in accordance with an example embodiment. During stage 1, the audio 1104 of a multimodal content item, such as a movie, is processed by an audio segment unit 1112 to generate audio objects 1120 that each identify one or more audio elements (such as a dog barking, the wind, and the like), a time period corresponding to the audio element(s) (such as t=30:02 to 30:10), and a spatial position (such as foreground, background, left side, and the like). During stage 1, the images 1108 of the multimodal content item are also processed by an image segment unit 1116 to generate image objects 1124 that identify one or more image elements (such as a dog running, a stationary train, and the like), a time period corresponding to the image element(s) (such as 1=31:00 to 31:35), and a spatial position. In one example embodiment, the audio objects 1120 also include information for reconstructing, or partially reconstructing the audio element(s). For example, a compressed version of the audio element(s) may be included. Similarly, the image object 1124 may also include information for reconstructing, or partially reconstructing the image element(s). For example, a compressed version of the image element(s) may be included. In one example embodiment, the audio segment unit 1112 and the image segment unit 1116 are implemented by neural networks. For example, generative adversarial networks (GANs), variational auto encoders (VAEs), and the like may be used to implement the audio segment unit 1112 and the image segment unit 1116.

During training, the audio segment unit 1112 is provided with the soundtracks of existing multimodal content items and their descriptions, including one or more specific labels that describe the type of sound, the duration of the sound, the spatial position of the sound, and the like. Since each soundtrack may include multiple sounds, a plurality of labels, a single label that identifies a plurality of sounds (such as sounds caused by trains, cars, horns, chatting, and the like) with a single composite identifier (such as “urban”); or a single label that identifies a plurality of sounds (such as car horn and people chatting) may be provided. Once trained, the audio segment unit 1112 is configured to generate the label types described above, including a specific label for each sound element in a given soundtrack. In one example embodiment, the audio segment unit 1112 also extracts the sound element and provides the extracted sound element as an output.

Similarly, during training, the image segment unit 1116 is provided with image sequences (such as video) of existing multimodal content items and their descriptions, including a specific label(s) that describes the type of object, the duration of the image object, the spatial position of the object, and the like. Since each image sequence may depict multiple objects, a plurality of labels may be provided, as described above in conjunction with audio labels. Once trained, the image segment unit 1116 is configured to generate the label types described above, including a specific label for each image object. In one example embodiment, the image segment unit 1116 also extracts the image object and provides the extracted image object as an output, such as a single image of the image object or a sequence of images of the image object.

During stage 2, the evolution of each audio element is tracked by an audio tracker 1128 to generate an audio element track 1136. For example, the audio element track 1136 may identify a dog barking at 1=30:02 to 30:10 and at 1=31:08 to 31:15 and the associated spatial position(s) of the sound. Similarly, the evolution of each image element is tracked by an image tracker 1132 to generate an image element track 1140. For example, the image element track 1140 may identify a dog running at 1=30:04 to 30:14 and at 1=31:15 to 31:22, and a dog sitting at 1=30:15 to 31:14 and the associated spatial positions (such as foreground for the running dog and background for the sitting dog). In one example embodiment, the audio tracker 1128 and the image tracker 1132 are implemented by neural networks, such as using generative adversarial networks (GANs).

During training, the audio tracker 1128 is provided with the label(s) that describe the type of sound, the duration of the sound, the spatial position of the sound, and the like that were generated by the audio segment unit 1112. Once trained, the audio segment unit 1112 is configured to generate the audio element track 1136 for each sound element in a given soundtrack. During training, the image tracker 1132 is provided with the label(s) that describe the type of image object, the duration of the image object, the spatial position of the image object, and the like generated by the image segment unit 1116. Once trained, the image tracker 1132 is configured to generate the image element track 1140 for each image object in a given image sequence.

During stage 3, the audio element track 1136 identifying, for example, a dog barking at t=30:02 to 30:10 and at t=31:08 to 31:15 and the image element track 1140 identifying, for example, a dog running at t=30:04 to 30:14 and at t=31:15 to 31:22, and a dog sitting at 30:15 to 31:14 are associated (linked) with each other by a connect unit 1144 to generate a summary stream 1148. In one example embodiment, the connect unit 1144 is implemented by a neural network, such as using a generative adversarial network (GAN).

During training, the connect unit 1144 is provided with audio element tracks 1136 and image element tracks 1140 that were previously generated by the audio tracker 1128 and the image tracker 1132, respectively. Once trained, the connect unit 1144 is capable of generating a summary stream 1148 (including the linked information of the audio element track 1136 and the image element track 1140) for a given multimodal content item based on the received audio element track(s) 1136, the received image element track(s) 1140, or both.

During stage 4, the summary stream 1148 is processed by an audio generator 1152 to generate 3D audio 1156, such as a 3D audio stream. In one example embodiment, the audio generator 1152 is implemented by a neural network, such as using a generative adversarial network (GAN). In one example embodiment, the summary stream 1148 is processed by a first neural network of the audio generator 1152 to generate stereo audio that was not contained previously in the audio channels and is related to the images given in the previous steps, and the stereo audio is processed by a second neural network of the audio generator 1152 to generate the 3D audio 1156. Once existing sounds and image objects are identified and the audio element track(s) 1136 and/or the image element track(s) 1140 are generated, new sounds are identified for generation by learning the relationship of the sound objects with other sound objects as well as learning the relationship of sound objects with image objects.

During training, the audio generator 1152 is provided with summary streams 1148 for each of a plurality of training multimodal content items. Once trained, the audio generator 1152 is configured to generate 3D audio 1156 for a given multimodal content item. In general, during the training phases, if the exact label is not found for a particular stage of system 1100 (stages 1-4), the corresponding model can use the closest label available.

Further regarding Stage 4, in one or more embodiments, neural generative models are used in Stage 4 to modify existing audio channels to use a 3D sound spatial distribution based on the image and sound from stage 3. For example, artificial intelligence (AI) models are used to generate complimentary sound tracks based on the sequences of images. Depending on previous or following image frames, the neural models generate new sounds. For example, if the following frames show a big forest and some people chattering in the distance, the models will generate these sounds for the current frame to complement the spatial sound information from existing audio.

In one or more embodiments, the neural models for generating the new sounds are trained using different categories of sounds. By applying noise on the trained models, it is possible to generate new sounds based on the previous knowledge (but being in fact new sounds). These models can generate the sound using regular audio channels (stereo) or directly in 3D sound spatial distributions (in parallel to the other models). If the new sounds are generated using a stereo setup, they will be sent to the other neural models that will transform them to the 3D sound spatial distribution (generating 3D audio sequentially).

### Generating New Sounds

The system 1100 is configured to utilize a variety of pre-defined audio and image sources, such as public databases or public audio streams, custom collections, private collections or other compilations of labelled soundtracks as training samples. Once trained, the following scenarios are supported in one or more embodiments:

### Image Labels Only

Generate sounds corresponding to an image object label (for example, an image object label identifying a dog generates a barking sound); and
generate sounds correlated to a plurality of image objects (for example, image object labels identifying a train station and people, respectively, generate an “all aboard” call; image object labels identifying a stadium of spectators and players in motion generates supplemental cheering sounds).

### Sound Labels Only

Generate sounds corresponding to an audio object label (for example, an audio object label identifying barking generates additional barking sounds, potentially at different spatial positions); and
generate sounds correlated to a plurality of audio objects (for example, audio object labels identifying a train whistle and people chatting generates an “all aboard” call).

### Image and Sound Labels

Generate sounds corresponding to or correlated with both one or more image object label(s) and one or more audio object label(s) (for example, an image object label identifying a shoreline together with an audio object label identifying the sound of waves crashing generates the sound of seagulls).

### Preempting Sounds

In certain instances, the generation of certain sounds should be preempted. For example, an image object label identifying a sleeping dog should avoid generating a sound of barking; a stadium with a single spectator should avoid generating a sound of a crowd cheering).

In one example embodiment, the generative models of the audio generator 1152 generate sound based on a selected type of sound and a seed of random data (or random noise). The models transform the random data or noise into a new sound that tries to imitate the selected sound. Thus, the random data/noise makes each generated sound different from both the sounds of the multimodal content that is to be modified as well as different from the sounds of the training data.

In one example embodiment, the models of one or more of the neural networks of stages 1-4 are adversarial: essentially two models that compete with each other are utilized. Consider, for example, the audio generator 1152. The first model (the generator) of the audio generator 1152 tries to generate a new sound, from random data or noise, which mimics a selected sound, while the other model of the audio generator 1152 (the discriminator) tries to determine whether the generated sound is indistinguishable from existing examples of the selected sound. The feedback from the discriminator model to the generator serves to improve the model of the generator. Once the generator is trained to generate sounds that cannot be distinguished by the discriminator from the existing examples of the selected sound, the models of the audio generator 1152 are considered as trained.

In one example embodiment, the models learn how to modify random data input to mimic a desired sound by mapping the latent space related to the problem or the task they want to mimic, and use frequentist approaches to learn how to produce the desired outputs from their parameters (features) (and not only from the output itself).

In one example embodiment, a specific model is trained for a single purpose, or limited range of purposes. For example, consider that the audio generator 1152 includes specialized models dedicated to generating sounds from nature, sounds from machines, and the like. Each sound identified for generation would be assigned to the appropriate specialized model.

The skilled artisan will be generally familiar with various types of neural networks, their implementation, training, and use for inferencing to solve a variety of problems. Generative Adversarial Networks (GANs) are a class of neural networks that are used for unsupervised learning; they are basically made up of a system of two competing neural network models (for example, neural network models that include a generator and discriminator) which compete with each other and are able to analyze, capture, and copy the variations within a dataset. In a GAN, the generator generates “fake” samples of data (be it an image, audio, etc.) and tries to “fool” the discriminator. The discriminator, on the other hand, tries to distinguish between the real and fake samples. The generator and the discriminator are both neural networks and they both run in competition with each other in the training phase. The steps are repeated several times and the generator and discriminator improve their performance after each repetition. In one example embodiment, the audio segment unit 1112, the image segment unit 1116, the image tracker 1132, the audio tracker 1128, the connect unit 1144, and the audio generator 1152 are implemented in software running on a high-powered computer, such as a computer based on graphical processing units (GPUs) and, optionally, using hardware accelerators. Thus, aspects of the invention can be implemented, for example, using software on a general-purpose computer (e.g., using digital processing and a typical Von Neumann architecture). Some embodiments could also make use of hardware-based solutions, in-memory computing, non-Von Neumann architectures, analog calculations, etc., for machine learning/artificial intelligence aspects. The skilled artisan will have familiarity with neural networks, including training thereof and inferencing therewith, and, given the teachings herein, can implement the elements depicted in the block diagram as set forth herein.

Given the discussion thus far, it will be appreciated that, in general terms, an exemplary method includes the operations of accessing, by a computing device, a multimodal (e.g., multimedia) content item 1104, 1108; and automatically generating, by the computing device, new three-dimensional sound 1156 using the one or more machine learning models 1112, 1116, 1128, 1132, 1144, 1152 based on the multimodal content item 1104, 1108. In one example embodiment, the multimodal content item 1104, 1108 is one of a video, a film, and a video game. As will be appreciated by the skilled artisan, the three dimensional sound is “new” in that it is generated based on, but differs from, the sound in the multimodal content item; for example, the multimodal content item includes only monaural or stereo sound while the newly generated sound is three dimensional.

In one example embodiment, the generating of the three-dimensional sound comprises processing, using a first neural network 1112 of the one or more machine learning models, audio 1104 of the multimodal content item to generate one or more audio objects 1120, wherein each audio object 1120 identifies an audio element, a time period corresponding to the audio object 1120, and a spatial position of the audio object 1120; processing, using a second neural network 1116 of the one or more machine learning models, one or more images 1108 of the multimodal content item to generate image objects 1124, wherein each image object 1124 identifies an image element, a time period corresponding to the image object 1124, and a spatial position of the image object 1124; tracking, using a third neural network 1128 of the one or more machine learning models, an evolution of each audio object 1120 to generate an audio element track 1136; tracking, using a fourth neural network 1132 of the one or more machine learning models, an evolution of each image object 1124 to generate an image element track 1140; linking, using a fifth neural network 1144 of the one or more machine learning models, at least one of the audio element tracks 1136 with at least one of: another of the audio element tracks 1136 and at least one of the image element tracks 1140 to generate a summary stream 1148; and processing, using a sixth neural network 1152 of the one or more machine learning models, the summary stream 1148 to generate an audio output 1156, the audio output 1156 comprising the three-dimensional sound.

In one example embodiment, at least one of the audio objects 1120 comprises information for reconstructing the audio object 1120. In one example embodiment, at least one of the image objects 1124 comprises information for reconstructing the image object 1124. In one example embodiment, the first neural network 1112 is trained using soundtracks of existing multimodal content items 1104, 1108 and their corresponding audio labels and the second neural network 1116 is trained using image sequences of the existing multimodal content items 1104, 1108 and their corresponding image labels. In one example embodiment, the third neural network 1128 is trained using training audio objects 1120 and their corresponding audio labels and the fourth neural network 1132 is trained using training image objects 1124 and their corresponding image labels.

In one example embodiment, the fifth neural network 1144 is trained using training audio element tracks 1136 and training image element tracks 1140. In one example embodiment, the sixth neural network 1152 is trained using a training summary stream 1148 generated from training data. One or more embodiments further include integrating the three-dimensional sound with the media content item; for example, based on labels and/or timestamps. The media content item with the integrated sound is then displayed to a user.

One or more embodiments further include an operation/method step of instantiating the first through sixth neural networks; for example, by configuring one or processors with instructions stored in a memory/computer readable storage medium.

In one aspect, an apparatus comprises a memory and at least one processor, coupled to the memory, and operative to perform any one, some, or all of the operations/method steps described herein.

In one aspect, a non-transitory computer readable medium comprises computer executable instructions which when executed by a computer cause the computer to perform any one, some, or all of the operations/method steps described herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

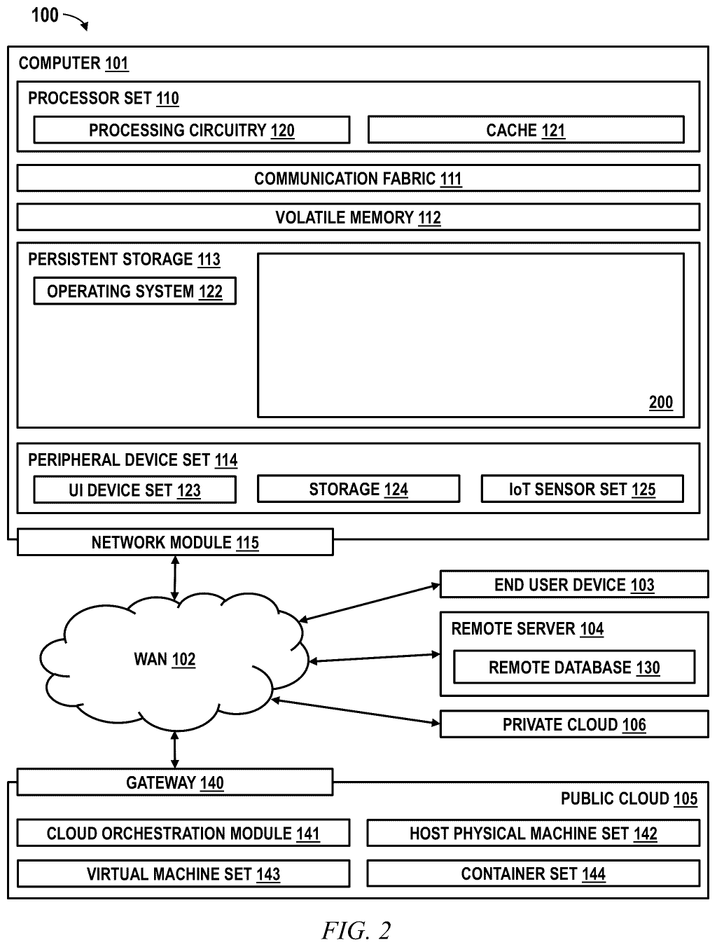

Refer now to FIG. 2.

Computing environment 100 contains an example of an environment for the execution of at least some of the computer code involved in performing the inventive methods, such as training models as described herein and/or deploying and running the trained models, as seen at 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments of the invention, or elements thereof, can thus be implemented in the form of an apparatus including a memory and at least one processor that is coupled to the memory and operative to perform exemplary method steps. FIG. 2 depicts a computer system that may be useful in implementing one or more aspects and/or elements of the invention

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
accessing, by a computing device, a multimodal content item; and
automatically generating, by the computing device, new three-dimensional sound using one or more machine learning models based on the multimodal content item.

2. The method of claim 1, wherein the multimodal content item comprises one of a video, a film, and a video game.

3. The method of claim 1, wherein the generating of the three-dimensional sound comprises:
processing, using a first neural network of the one or more machine learning models, audio of the multimodal content item to generate one or more audio objects, wherein each audio object identifies an audio element, a time period corresponding to the audio object, and a spatial position of the audio object;
processing, using a second neural network of the one or more machine learning models, one or more images of the multimodal content item to generate image objects, wherein each image object identifies an image element, a time period corresponding to the image object, and a spatial position of the image object;
tracking, using a third neural network of the one or more machine learning models, an evolution of each audio object to generate an audio element track;
tracking, using a fourth neural network of the one or more machine learning models, an evolution of each image object to generate an image element track;
linking, using a fifth neural network of the one or more machine learning models, at least one of the audio element tracks with at least one of: another of the audio element tracks and at least one of the image element tracks to generate a summary stream; and
processing, using a sixth neural network of the one or more machine learning models, the summary stream to generate an audio output, the audio output comprising the new three-dimensional sound.

4. The method of claim 3, wherein at least one of the audio objects comprises information for reconstructing the audio object.

5. The method of claim 3, wherein at least one of the image objects comprises information for reconstructing the image object.

6. The method of claim 3, further comprising training the first neural network using soundtracks of existing multimodal content items and their corresponding audio labels and training the second neural network using image sequences of the existing multimodal content items and their corresponding image labels.

7. The method of claim 3, further comprising training the third neural network using training audio objects and their corresponding audio labels and training the fourth neural network using training image objects and their corresponding image labels.

8. The method of claim 3, further comprising training the fifth neural network using training audio element tracks and training image element tracks.

9. The method of claim 3, further comprising training the sixth neural network using a training summary stream generated from training data.

10. The method of claim 3, further comprising integrating the three-dimensional sound with the media content item.

11. An apparatus comprising:
a memory; and
at least one processor, coupled to the memory, and operative to perform operations comprising:
accessing a multimodal content item; and
automatically generating new three-dimensional sound using one or more machine learning models based on the multimodal content item.

12. The apparatus of claim 11, wherein the at least one processor is operative to generate the three-dimensional sound by:
processing, using a first neural network of the one or more machine learning models, audio of the multimodal content item to generate one or more audio objects, wherein each audio object identifies an audio element, a time period corresponding to the audio object, and a spatial position of the audio object;
processing, using a second neural network of the one or more machine learning models, one or more images of the multimodal content item to generate image objects, wherein each image object identifies an image element, a time period corresponding to the image object, and a spatial position of the image object;
tracking, using a third neural network of the one or more machine learning models, an evolution of each audio object to generate an audio element track;
tracking, using a fourth neural network of the one or more machine learning models, an evolution of each image object to generate an image element track;
linking, using a fifth neural network of the one or more machine learning models, at least one of the audio element tracks with at least one of: another of the audio element tracks and at least one of the image element tracks to generate a summary stream; and
processing, using a sixth neural network of the one or more machine learning models, the summary stream to generate an audio output, the audio output comprising the three-dimensional sound.

13. The apparatus of claim 12, wherein at least one of the audio objects comprises information for reconstructing the audio object.

14. The apparatus of claim 12, wherein at least one of the image objects comprises information for reconstructing the image object.

15. The apparatus of claim 12, wherein the at least one processor is further operative to train the first neural network using soundtracks of existing multimodal content items and their corresponding audio labels and to train the second neural network using image sequences of the existing multimodal content items and their corresponding image labels.

16. The apparatus of claim 12, wherein the at least one processor is further operative to train the third neural network using training audio objects and their corresponding audio labels and to train the fourth neural network using training image objects and their corresponding image labels.

17. The apparatus of claim 12, wherein the at least one processor is further operative to train the fifth neural network using training audio element tracks and training image element tracks.

18. The apparatus of claim 12, wherein the at least one processor is further operative to train the sixth neural network using a training summary stream generated from training data.

19. A computer readable storage medium comprising computer executable instructions which when executed by a computer cause the computer to perform the method of:
accessing a multimodal content item; and
automatically generating new three-dimensional sound using one or more machine learning models based on the multimodal content item.

20. The computer readable storage medium of claim 19, wherein the generating of the three-dimensional sound comprises:
processing, using a first neural network of the one or more machine learning models, audio of the multimodal content item to generate one or more audio objects, wherein each audio object identifies an audio element, a time period corresponding to the audio object, and a spatial position of the audio object;
processing, using a second neural network of the one or more machine learning models, one or more images of the multimodal content item to generate image objects, wherein each image object identifies an image element, a time period corresponding to the image object, and a spatial position of the image object;
tracking, using a third neural network of the one or more machine learning models, an evolution of each audio object to generate an audio element track;
tracking, using a fourth neural network of the one or more machine learning models, an evolution of each image object to generate an image element track;
linking, using a fifth neural network of the one or more machine learning models, at least one of the audio element tracks with at least one of: another of the audio element tracks and at least one of the image element tracks to generate a summary stream; and
processing, using a sixth neural network of the one or more machine learning models, the summary stream to generate an audio output, the audio output comprising the three-dimensional sound.
